(19) United States
(12) Patent Application Publication
(10) Pub. No.: US 2019/0047183 A1
(43) Pub. Date: Feb. 14, 2019

(54) Rubber-Steel Composite Structures

(71) Applicant: G. B. Kirby Meacham, Cleveland, OH (US)

(72) Inventor: G. B. Kirby Meacham, Cleveland, OH (US)

(21) Appl. No.: 16/046,913

(22) Filed: Jul. 26, 2018

Related U.S. Application Data
(60) Provisional application No. 62/543,460, filed on Aug. 10, 2017.

(51) Int. Cl. B29C 35/04; B32B 15/082; B32B 15/18; B32B 27/26; B32B 25/14; C08L 21/00; B29C 35/08

(52) U.S. Cl. CPC B29C 35/049; B32B 15/082; B32B 15/18; B32B 27/26; B32B 25/14; B29C 2035/046; B29C 35/08; B29C 35/045; B32B 2311/30; C08L 2312/00; C08L 21/00

(57) ABSTRACT

This invention comprises novel large vulcanized rubber-steel composite water contacting hydraulic structures such as flood gates, lock gates and penstocks that are essential elements of hydroelectric power generation stations and marine navigation facilities such as locks and canals that have an expected service life of decades to a century or more. The composite structures have reduced susceptibility to damage and corrosion and prolonged service life compared to prior art painted metal structures. It is further directed to safe and environmentally benign means for onsite or shop fabrication of such composite structures incorporating in part either existing steel structures or new steel structures.

This application claims the priority of U.S. provisional patent application 62/543,460 filed Aug. 10, 2017.

### FIELD OF THE INVENTION

The present invention is directed to novel large vulcanized rubber-steel composite water contacting hydraulic structures such as flood gates, lock gates and penstocks with reduced susceptibility to damage and corrosion and prolonged service life. It is further directed to safe and environmentally benign means for onsite or shop fabrication of such composite structures incorporating in part either existing steel structures or new steel structures.

### BACKGROUND OF THE INVENTION

Large water-contacting steel hydraulic structures such as flood gates, lock gates and penstocks are essential elements of hydroelectric power generation and marine navigation facilities such as locks and canals that have an expected service life of decades to a century or more. These steel hydraulic structures are in intermittent or continuous contact with water in the presence of oxygen, and are therefore subject to corrosion which results in material loss. If uncontrolled, corrosion may lead to failure or the need for major repairs or replacement resulting in high costs and well as loss of service of the facility. High water flow rates, particularly in penstocks, and debris in water contacting flood gates and lock gates can cause abrasion that accelerates the corrosion process.

Steel corrosion in hydraulic structures is an electrochemical cell process in which oxygen dissolved in water takes up electrons from the elemental iron in steel producing iron ions that form iron hydroxide or rust in the presence of water. The electrons are conducted through the metallic steel that forms the anode of the cell to the rust that forms the cathode, and the iron ions diffuse through the water that serves as the electrolyte. The electrical potential driving the reaction is about a volt. The rust does not adhere tightly to the base metal, so rust formation exposes a fresh base metal surface resulting in continuing corrosion.

Paint or a similar coating typically forms the first line of defense against this steel corrosion process except in wear areas such as seal or guide plates. Ideally it forms a barrier that prevents water and/or oxygen contact with the metallic steel, eliminating the conditions required for corrosion. Often the coating contains a material such as zinc or aluminum that is more electrochemically active than iron so that it is sacrificed to protect the steel if small amounts of oxygen and water begin to penetrate the coating. Flaws in the initial coating or that develop later as the result of mechanical damage or aging can allow rust to develop and spread under the coating, often causing the coating to blister and detach. Cathodic protection systems are typically used to reduce corrosion caused by coating flaws by impressing a voltage between inert electrodes in the water and the steel, making the steel structure a cathode in an electrochemical cell. The current required is a function of the area of steel exposed to the water, so minimum exposed area is desirable. Wear areas are typically only a small fraction of the total area, and may be protested by spray coating of corrosion resistant metal or the cathodic protection system.

Coal tar enamel with red lead primer and solution vinyl coatings provide decades of protection for hydraulic structures. Further, they can be applied in the field to existing structures. Their use, however, requires extensive mitigation to comply with Occupational Health and Safety Administration (OSHA) standards. Coal tar and lead are recognized as toxic chemicals and the high solvent content of vinyl coatings introduces application worker safety concerns. Lead in particular, and to a lesser extent coal tar, require careful removal at the end of service life to avoid environmental contamination or a hazard to workers.

Rubber cladding of steel structures such as pipes and vessels in the processing and chemical storage and transport industries to provide abrasion and corrosion resistance under aggressive conditions is established technology. Synthetic rubbers such as EPDN (Ethylene Propylene Diene PolyMethylene) and natural rubber may both be formulated to have excellent adhesion to bare steel. EPDM has excellent resistance to ultraviolet light and ozone exposure, and is widely used as the exposed membrane barrier in commercial roofing. Natural rubber is not ultraviolet and ozone resistant, but its abrasion resistance makes it a good choice where such exposure is not a factor. Typically sheets of uncured rubber, which can be very malleable and tacky, are applied to a clean steel surface or a steel surface coated with a primer and adhesive system that may be organic solvent based but is preferably water based. The structure is then cured inside a steam autoclave to vulcanize the rubber so that it becomes a non-malleable elastomer permanently bonded to the steel. For some structures such as tanks and pipes the rubber is vulcanized by forming a closed volume and filling it with low pressure steam. The vulcanization time and temperature varies with the rubber composition and chemical curing system, but is typically over 20 minutes and 125 degrees C. In addition to providing durable protection of the steel, rubber cladding of steel using water based primer systems does not present safety or environmental issues often associated with other coating systems. There are no volatile organic solvents that could pose a fire hazard or health risk to application workers, and at the end of its service life the rubber is nontoxic and does not pose a hazard to the environment.

Steam autoclaving is not the only way to heat-cure coatings. The cargo tanks of tanker ships are often coated with epoxy to protect both the steel tank surfaces and the liquid cargos by providing corrosion protection and easily washed surfaces that reduce cross-contamination when the type of cargo changes. Such coatings are usually applied as liquids that dry to form a film, but full cure may require temperatures as high as 200 degrees C. Circulating hot air is a preferred heating means since it is reasonably uniform, accommodates complex geometries, and, unlike steam, can supply heat over 100 degree C. at atmospheric pressure. Typically temperatures are measured at multiple points in the tank to facilitate process monitoring and control. Induction heating or infrared heating of metal parts to cure coatings is also known, and has the advantages of being a rapid heating method in which the heat may be largely confined to selected areas. Steam at atmospheric pressure may also be used if the vulcanization temperature is about 100 degrees C.

Rubber tires are another example of durable and high performance structures combining vulcanized elastomer with steel and other structural materials. The elastomer provides abrasion resistance, impermeability to air, and protects the steel from corrosion. While the exterior of tires is a compromise between weathering resistance and other engineering properties, the long term persistence of scrap tires in the environment is empirical evidence of their environmental durability.

The potential utility of vulcanized rubber-steel composite hydraulic structures resistant to abrasion and corrosion is clear from the successful application of related technology in the process, chemical transport, and tire industries, but to the Inventor's knowledge such composite hydraulic structures are not known. EPDM is a candidate for exposed steel structures such as flood gates and lock gates, and both EPDM and natural rubber are candidates for water-filled penstocks. For such composite structures to be practical, however, techniques and equipment must be devised or adapted to apply and vulcanize the rubber in place on existing or new steel structures in the field without relying on conventional steam autoclaves.

### SUMMARY OF THE INVENTION

The present invention is directed to rubber-clad steel hydraulic structures, and to techniques and equipment to apply and vulcanize rubber in place on existing steel structures in the field without relying on conventional steam autoclaves. In broad outline:
1. If necessary water is removed from the structures and the surfaces to have rubber applied are cleaned using conventional means to expose a sound substrate. This may be bare metal or sound previous coatings with acceptable adhesion to the vulcanized rubber. Water based primer and adhesive systems are available that improve adhesion and protect bare metal from oxidation in the time period between cleaning and rubber application.
2. The geometry of the surfaces is determined to plan the installation. Data sources may include original design drawings, manual field measurements, and automated field measurements using known methods such as laser scanning. The geometry is used to determine the types and amount of material required, and provides the opportunity to precut rubber sheets in the shop to save time onsite. It also allows the design and shop fabrication or molding of custom shapes for struts, corners and similar details that save time and improve quality by reducing the need for cutting and piecing together sheet onsite.
3. Rubber sheets are applied to the surfaces and adhere through their own tackiness. The sheets may be totally uncured fully malleable rubber or a layer of uncured rubber bonded to a cured rubber membrane. The uncured sheets are advantageous for covering complex shapes such as rivet heads, and the sheets with cured membrane are advantageous for covering flat or simply curved surfaces. Tools such as rollers are used to assure intimate contact between the steel and rubber, and uncured rubber may be applied by caulking guns or in rope-like forms to fill crevices in the structure, gaps between rubber sheets where lap joints are not used, and to thicken thin areas over steel protrusions. Further, molded and cured rubber shapes such as hat-shaped cups to cover bolt ends and pyramid shapes to protect and seal inside and outside corners may be used in conjunction with uncured rubber. Automation is expected to be applicable to some simple planar and cylindrical surfaces, while manual application may be the only option for struts, ribs, recesses and other complex surfaces.
4. The uncured rubber covering is visually inspected and tested by known means such as spark testing to locate dielectric flaws that are then repaired.
5. The steel and rubber composite are heated for the time and temperature required to achieve vulcanization. Heated air circulated over the structure and contained by a heat-resistant fabric tent-like structure is a preferred heating method since it is suited to in-situ use in the field, is at atmospheric pressure, and accommodates complex geometry such as radial and miter gates. Instrumentation such as thermocouples and thermal imaging cameras are used to monitor and control the vulcanization process. Hot air heating may be supplemented by means including radiant heating and induction heating in areas in thermal contact with adjacent structures that act as heat sinks.

The net result is a vulcanized rubber-steel composite structure wherein an impervious elastomer layer bonded to the steel encloses the steel and resists corrosion, abrasion, and impact for an extended period of time except in wear areas. In particular elastomer resists chipping and cracking hazards common to rigid polymer coatings, and will form an effective barrier even if it is debonded from the steel over a limited area. The materials are proven for weathering resistance in roofing applications and for corrosion resistance in applications in the processing and chemical storage and transport industries under conditions far more aggressive than exposure to cool fresh water. Transient exposure to most hydrocarbons will result in swelling, but will not degrade the protective performance of the elastomer. Inspection using methods such as spark testing and any necessary field repairs may be carried out over the life of the composite structure by known means used for rubber tank linings.

### DESCRIPTION OF DRAWINGS

The appended claims set forth those novel features that characterize the invention. However, the invention itself, as well as further objects and advantages thereof, will best be understood by reference to the following detailed description. The accompanying drawings, where like reference characters identify like elements throughout the various figures in which:

FIG. 1 shows sections through portions of composite vulcanized rubber-steel hydraulic structures that illustrate the composite structure;

FIG. 2 shows show the formation of an exemplary lap seam between two rubber sheets;

FIG. 3 shows show a preferred configuration for covering a step in a steel substrate with a rubber sheet;

FIG. 4 shows a show a preferred configuration for covering a steel substrate edge with rubber sheet;

FIG. 5 shows examples of prefabricated elements that speed up and simplify the fabrication of composite vulcanized rubber-steel hydraulic structures; and

FIG. 6 is a schematic illustrating a preferred means of vulcanizing the rubber portions of a vulcanized rubber-steel composite hydraulic structure at atmospheric pressure.

### DETAILED DESCRIPTION OF THE INVENTION

Upon examination of the following detailed description the novel features of the present invention will become apparent to those of ordinary skill in the art or can be learned by practice of the present invention. It should be understood that the detailed description of the invention and the specific examples presented, while indicating certain embodiments of the present invention, are provided for illustration purposes only. Various changes and modifications within the spirit and scope of the invention will become apparent upon examination of the following detailed description of the invention and claims that follow.

The invention is described with reference to the exemplary vulcanized rubber-steel hydraulic structure features shown in the figures, but it is to be understood that the invention is applicable to a variety of configurations.

The invention comprises novel composite hydraulic structures that combine the load-bearing capabilities of steel with the corrosion and abrasion and weathering resistance of vulcanized rubber using combinations of several technologies and physical phenomena:
1. Vulcanized rubber is a crosslinked elastic thermoset elastomeric material notable for ability to remain flexible at low temperatures and lack of softening at high temperatures. This service range far exceeds the variation in temperature typical of hydraulic structures. Several elastomer choices are available that optimize the resistance to attack by different environmental and chemical exposure conditions, and fillers and other additives allow adjustment of a variety of properties ranging from strength to abrasion resistance to color. Importantly for the composite hydraulic structure application, permanent bonding of vulcanized rubber to steel with a bond strength that equals or exceeds the strength of the rubber itself is routine.
2. Uncured rubber may be formed into sheets that are very tacky and readily adhere to bare steel, primed steel, and other uncured or vulcanized rubber at ambient temperature and without use of solvents. The principal requirement is that the surfaces be clean, dry, optionally primed and adhesive coated, and free of release agents. Uncured rubber will vulcanize slowly at ambient temperature, but the useful shelf life is typically on the order of months so factory production and, optionally, custom pre-cutting and forming to save time on the job site is practical.
3. The process of building the composite structure is inherently flexible. The steel must be dry when the uncured rubber is applied, but the composite may be submerged before vulcanization. In addition, uncured rubber will bond to vulcanized rubber so the work may be carried out in sections. While heat vulcanization is preferred, all or part of the rubber in the composite structure may be vulcanized at ambient temperature, even in the flooded condition, so long as mechanical stresses are minimized during the curing period.
4. Inspection and corrections are simple prior to and after vulcanization. The dielectric continuity of the rubber may be verified using known spark testing methods employing potential on the order of 10,000 volts across the rubber layer. Forward Looking Infrared (FLIR) cameras can detect unbonded areas through temperature differences between rubber in full contact with the steel and rubber in incomplete contact. Transient hot air or radiant heating may be applied during the measurement to increase the contrast. Repairs can then be made to either uncured or cured rubber and reinspected.

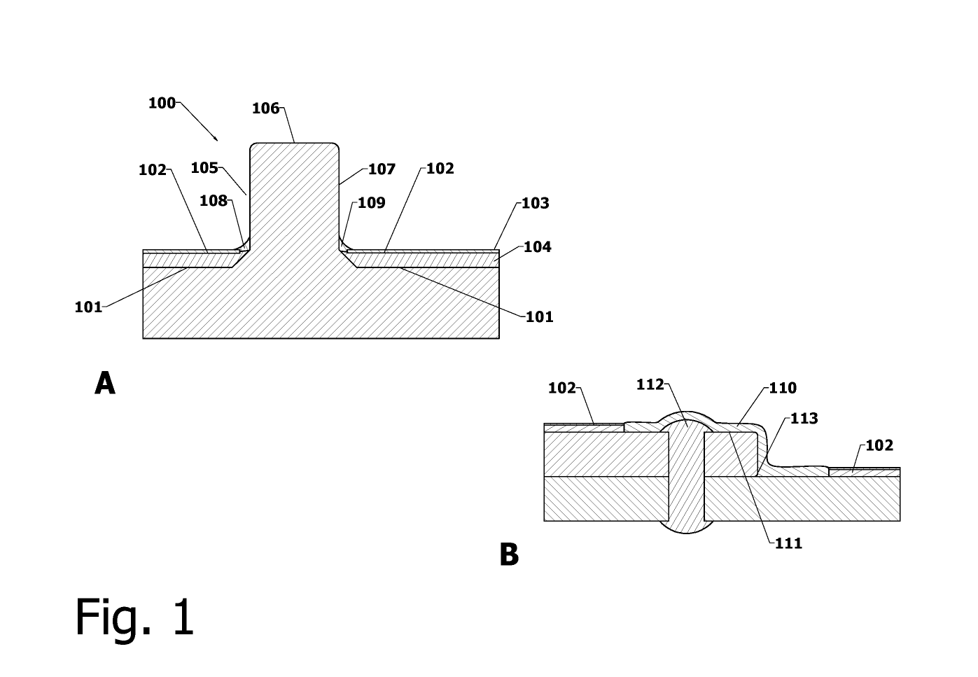

FIG. 1A shows a section through a portion of a composite vulcanized rubber-steel hydraulic structure 100 according to the invention. Non-wear steel surfaces 101 are covered with sheets of rubber 102 that are bonded to the surfaces prior to vulcanization. In this example sheets 102 comprise a vulcanized outer rubber layer 103 and a factory-applied uncured rubber layer 104 that adheres to the steel 101. Such two-layer sheets are only tacky on one side, and are easier to handle and apply than a single layer of uncured rubber that is tacky on both sides, and are preferred for generally planar and simply curved surfaces. After vulcanization 103 and 104 become a monolithic layer bonded to surfaces 101. Surfaces 105-107 are wear surfaces that are protected by other means. Preferably the exposed surface of the outer vulcanized layer sheet 103 is buffed or otherwise cleaned so that uncured rubber will adhere. This facilitates addition of uncured rubber such as that forming fillets 108 and 109, and also facilitates formation of lap joints as discussed below.

FIG. 1B shows the use of uncured rubber sheet 110 in in conjunction with two layer sheet 102 to cover a more complex steel surface 111 including rivet heads 112 and a step 113. Non-stick polymer film, gloves, or tools are required to apply the tacky sheet 110, but not the two layer sheet 102. After vulcanization the combined covering becomes a monolithic elastomer layer covering the surface 111.

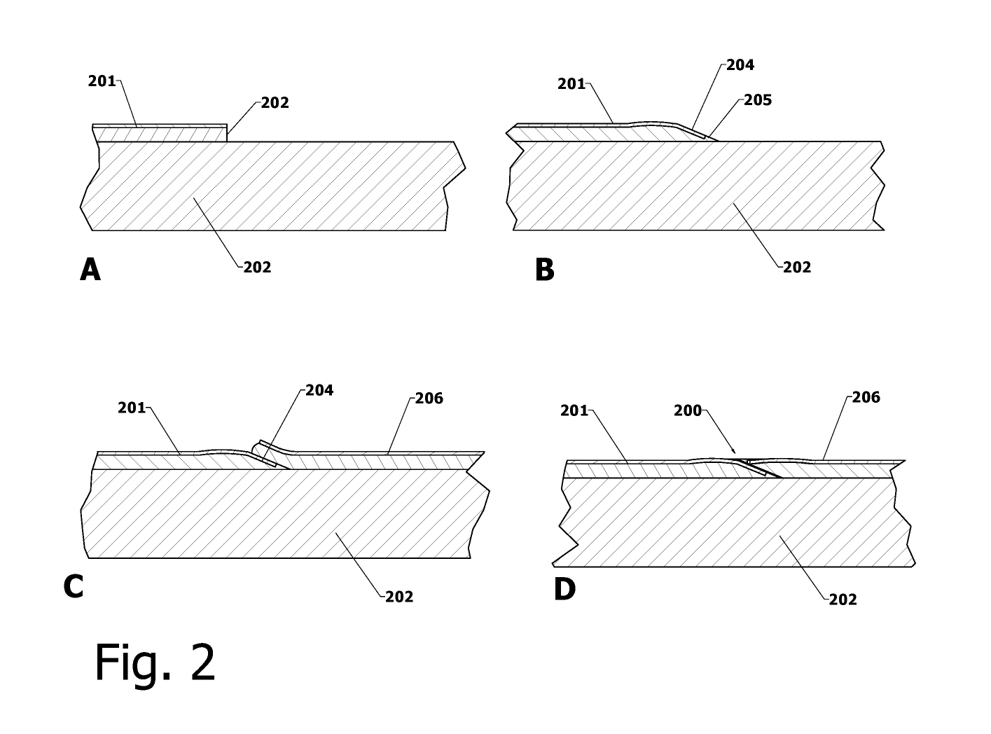

FIG. 2A-FIG. 2D show the formation of an exemplary lap seam 200 between two layer sheets 102. A first sheet 201 is bonded to the substrate 202 as shown in FIG. 2A, and its edge 203 is formed to a bevel 204 as shown in FIG. 2B with a tool such as a roller made of material that does not stick to the uncured rubber 205 that extrudes out from under the edge of the vulcanized top sheet 103. A second sheet 206 is then applied and bonded to the substrate 202 such that it at least partially overlaps the bevel 204 as shown in FIG. 2C. The seam is finished as shown in FIG. 2D by pressing down with a non-stick tool to exclude air and form a smooth seam 200 without the need to add uncured rubber.

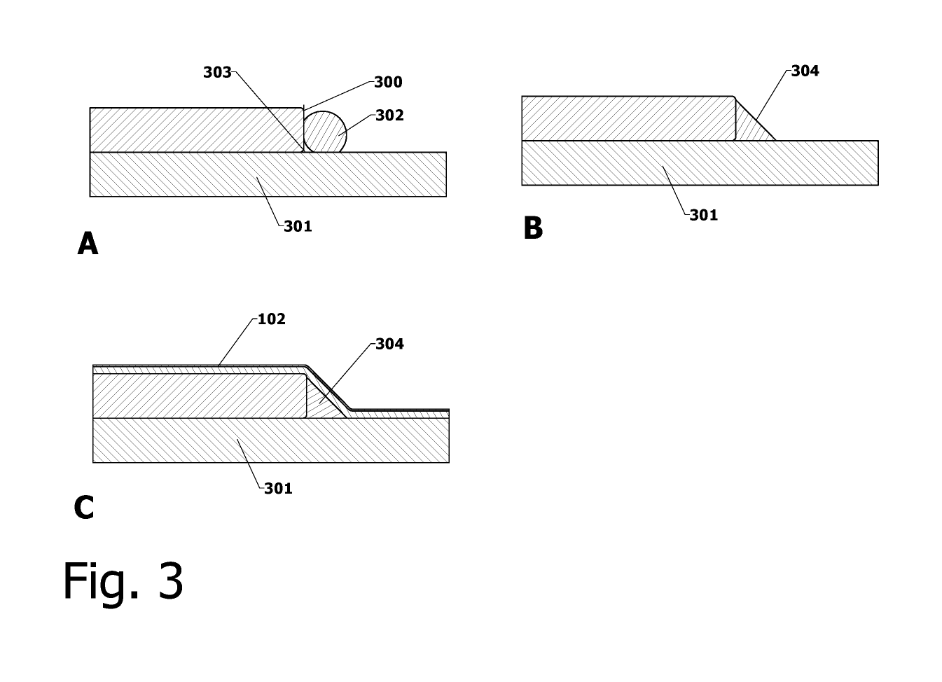

FIG. 3A-FIG. 3C show a preferred configuration for covering a step 300 in a steel substrate 301 with two layer sheet 102. Uncured rubber 302 in the form or a preformed rope or caulking bead is placed in the step inside corner 303 as shown in FIG. 3A and pressed into the corner to eliminate air spaces and form a bevel 304 with a non-stick tool as shown in FIG. 3B. Two layer sheet 102 is then adhered to the substrate 301 and the bevel 304.

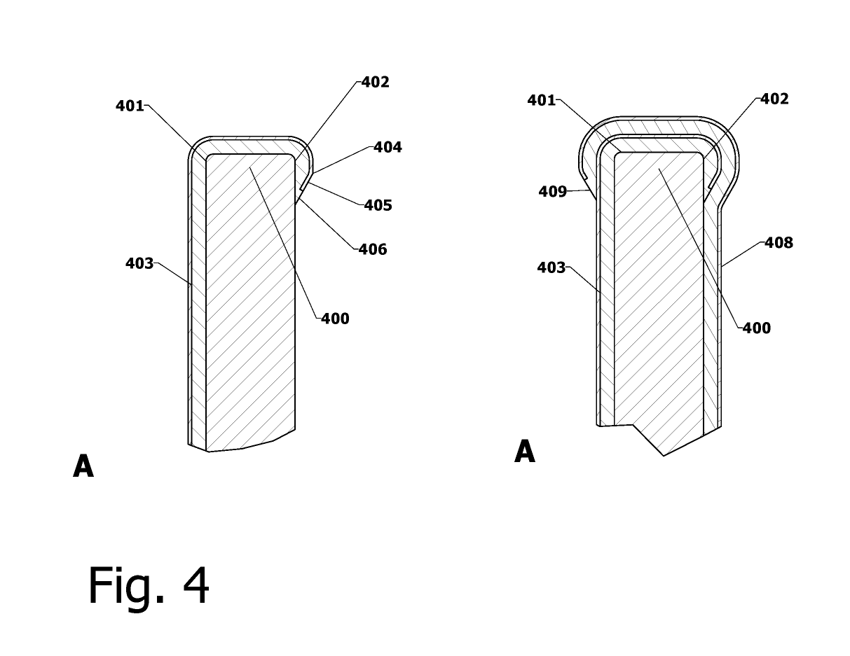

FIG. 4A and FIG. 4B show a preferred configuration for covering a steel substrate edge 400 with two corners 401 and 402 with two layer sheet 102. A first sheet 403 is bonded to the substrate edge 400 as shown in FIG. 4A such that it wraps around and covers the corners 401 and 402, and the sheet edge 404 is formed to a bevel 405 with a non-stick tool such that the uncured rubber 406 that extrudes out from under the edge of the vulcanized top sheet 103 and forms a smooth bevel 407. A second sheet 408 is then applied and bonded to the substrate edge 400 such that it overlays the first sheet 403 and also wraps around the corners 401 and 402 as shown in FIG. 4B, thereby protecting the corners with two layers of rubber. The edge of the second sheet 408 is then formed into a bevel 409 with a non-stick tool to provide a finished seam.

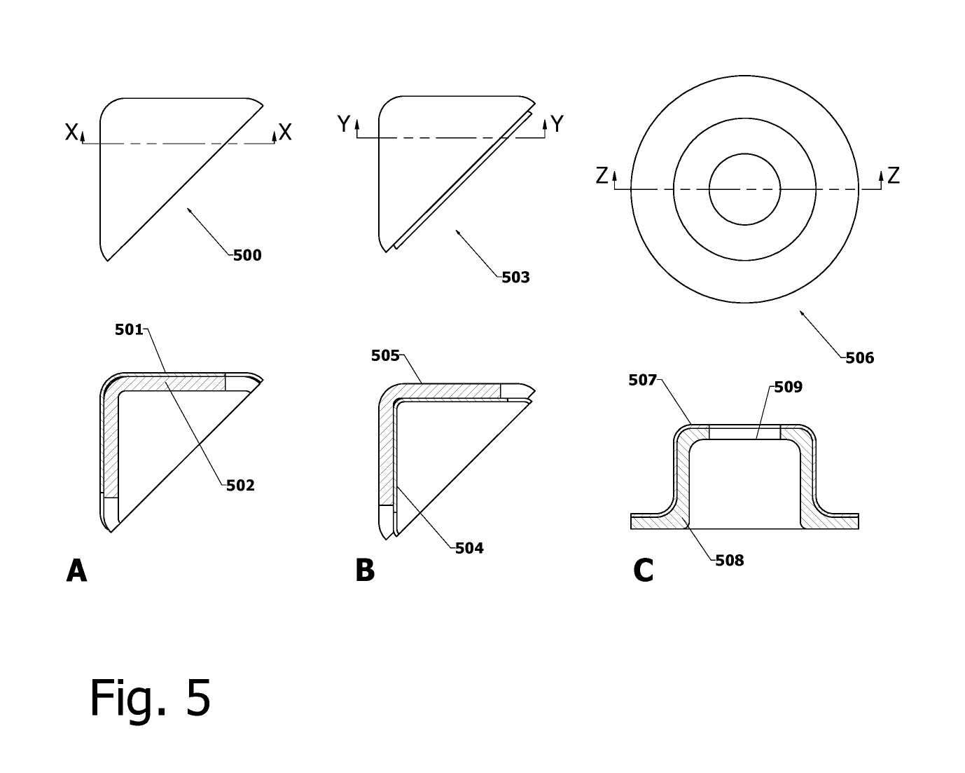

FIG. 5 shows examples of prefabricated elements that speed up and simplify the fabrication of composite vulcanized rubber-steel hydraulic structures. FIG. 5A shows an outside corner finishing element 500 comprising a pyramid shaped vulcanized rubber shell 501 lined with uncured rubber 502. It is adhered to an outside steel substrate corner either before or after sheet rubber is applied to provide a seal and additional thickness to protect the corner. FIG. 5B shows an inside corner finishing element 503 comprising a pyramid shaped vulcanized rubber shell 504 covered with uncured rubber 505. It is adhered to an inside steel substrate corner either before or after sheet rubber is applied to simplify the sealing process. FIG. 5C shows a protrusion finishing element 506 comprising a hat-shaped vulcanized rubber shell 507 lined with uncured rubber 508 and further comprising an access hole 509. It is adhered to a protruding steel bolt and nut or bolt head either before or after sheet rubber is applied to provide a seal and additional thickness to protect the protrusion. Preferably the protrusion is pre-coated with uncured rubber, and uncured rubber may be added through the access hole 509 to assure complete fill. Optionally the shells 501 and 507 may be made of metal such as passivated stainless steel to provide additional resistance to damage to outside corners or protrusions. These are examples only, and it will be obvious to those of ordinary skill in the art that a variety of similar prefabricated elements may be devised for other geometries.

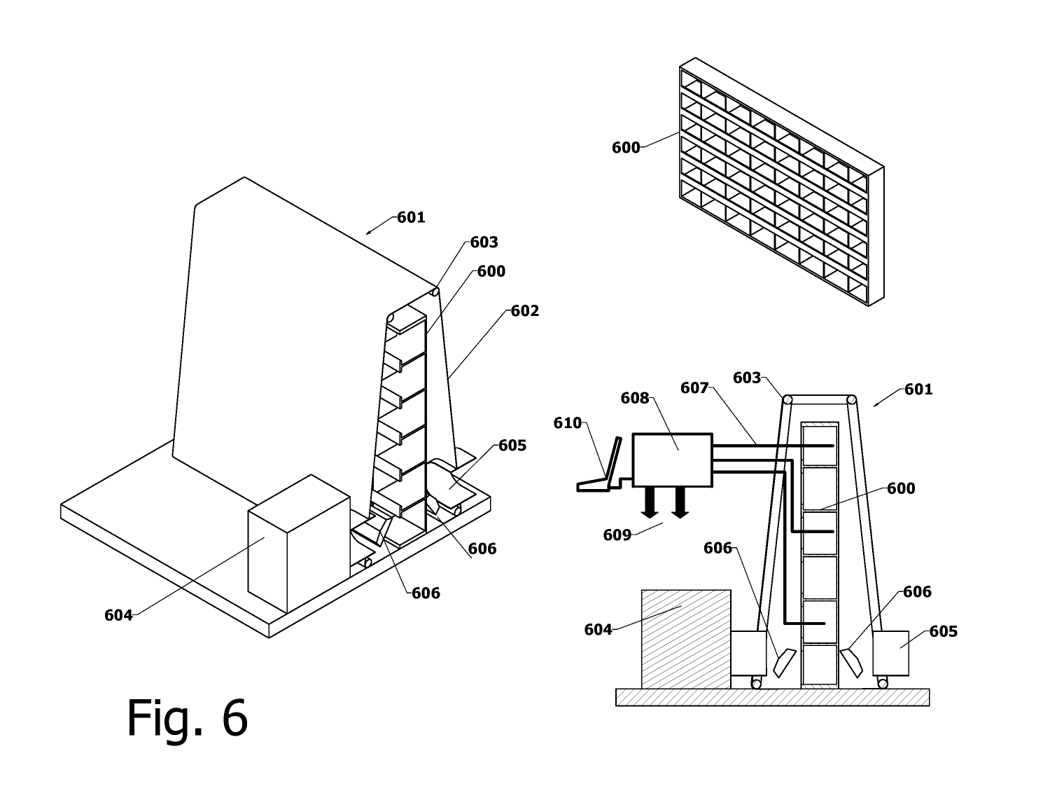

FIG. 6 is a schematic illustrating a preferred means of vulcanizing the rubber portions of a vulcanized rubber-steel composite hydraulic structure 600. A tent-like enclosure 601 comprising heat resistant fabric 602 supported by framing 603 is erected to enclose the structure 600. Silicone coated fiberglass fabric is one example of heat and flame resistant fabric suitable for the purpose. One or more heaters 604 are arranged to blow air into the enclosure 601 at or slightly above the temperature required for vulcanization. The hot air contacts and circulates around the composite structure 600 to heat the structure, and then exits through one or more exhaust vents 605. Optionally radiant heaters 606 supplement the hot air to achieve more uniform heating. Multiple temperature probes 607 may be used to measure the temperature of composite structure 600, and the measurements may be used as input to an automatic controller 608 that provides output signals 609 to regulate the heat output of the air heaters 604 and the radiant heaters 606 to maintain specified time and temperature conditions. An operator interface 610 permits monitoring and control of the process. It will be obvious to those of ordinary skill in the art to use similar equipment and methods to form composite structures comprising a steel penstock and a vulcanized rubber liner in situ. Further, it will be obvious that the vulcanization times and temperatures may be varied by changes in the rubber formulation, and that there are time-temperature tradeoffs for a given formulation that include ambient temperature vulcanization over an extended time period.

What is claimed is:

1. Vulcanized rubber-steel composite structures, including but not limited to hydraulic structures, wherein at least a portion of the steel surface is covered with uncured rubber that is bonded in place and then vulcanized at atmospheric pressure.

2. Vulcanized rubber-steel composite structures according to claim 1 wherein vulcanization is accelerated by one or more of hot air heating, radiant heating, induction heating or steam heating at atmospheric pressure.

3. Vulcanized rubber-steel composite structures according to claim 2 wherein vulcanizing heat is contained to the vicinity of the structures by means including but not limited to tent-like fabric barriers.

4. Vulcanized rubber-steel composite structures according to claim 1 wherein at least a portion of the uncured rubber bonded to the steel has an outside skin layer of vulcanized rubber, metal, or similar material 7.
